(19) United States
(12) Patent Application Publication
(10) Pub. No.: US 2023/0048034 A1
(43) Pub. Date: Feb. 16, 2023

(54) DEVICE FOR A CRUSHER

(71) Applicant: Rubble Master HMH GmbH, Linz (AT)

(72) Inventors: Bernardo Niederhageböck, München (DE); Martin Wheatley, Burton On Trent Staffordshire (GB)

(21) Appl. No.: 17/784,351

(22) PCT Filed: Jan. 13, 2021
(86) PCT No.: PCT/AT2021/060011

§ 371 Date: Jun. 10, 2022

(30) Foreign Application Priority Data
Jan. 13, 2020 (AT) A50016/2020

(51) Int. Cl. B02C 1/04

(52) U.S. Cl. CPC B02C 1/04; B02C 1/005

(57) ABSTRACT

A device for a crusher comprises a frame (2) for a crushing chamber (8). The frame comprises a crossmember (1), and the crushing chamber is delimited by a crushing jaw (5) that is drivably connected to a reciprocating piston (4) inserted into a hollow cylinder (3). To reduce the material fatigue, the weight and the space requirements of the device while achieving the same mechanical stability, the swept volume of the hollow cylinder (3) lies completely within the crossmember (1).

### FIELD OF THE INVENTION

The invention relates to a device for a crusher, comprising a frame for a crushing chamber, which frame comprises a crossmember, with the crushing chamber being delimited by a crushing jaw which is drivably connected to a reciprocating piston inserted into a hollow cylinder.

### DESCRIPTION OF THE PRIOR ART

Various devices for jaw crushers are known from the prior art. All of them are based on the principle of preventing damage to the crushing jaws of a jaw crusher by retracting the movable crushing jaw from the opposite crushing jaw via a lifting system if a non-crushable object enters the crushing gap. This is because the forces caused by such an object can lead to damage to the components involved. Even with a controlled adjustment of the crushing gap width, reaction forces occur due to the inertia of the components, which stress the involved components. An important aspect to be considered in the design of a device is therefore the dissipation and distribution of these undesirable, occurring forces from the crushing jaw into the supporting structure of the jaw crusher. In the prior art, this is usually done via a mechanical connection of the lifting system to a crossmember, via which the forces are introduced and distributed into the side cheeks as the frame of the jaw crusher.

EP2662141B1 discloses a support frame with lifting system, in which the lifting cylinder of the lifting system is supported against the crossmember of the frame and stiffening elements are provided in the crossmember to dissipate the forces that occur. The piston of the lifting system is connected to the movable crushing jaw via a lever.

U.S. Pat. No. 6,375,105B1 shows a crossmember forming a support. Here, too, a lifting system with hollow cylinders is shown, in which the hollow cylinders are mounted at their cylinder heads on the side of the beam facing away from the crushing chamber.

Thus, prior art devices require solid components and a robust connection of the components involved, so that materially bonded connections, solid flanges or additional stiffening elements are usually provided. These additional elements increase space requirements, design effort and maintenance intensity. For example, EP2662141B1 connects the crossmember centrally rather than peripherally to the lifting system, which requires a recess in the crossmember for the lifting system. However, this necessary recess means that the crossmember must be designed to be more stable than with edge-side mounting, which increases the overall weight.

### SUMMARY OF THE INVENTION

The invention is thus based on the object of providing a device that reduces material fatigue while maintaining the same mechanical stability and is lighter and more space-saving without additional stabilizing elements.

The invention solves the problem posed by ensuring that the swept volume of the hollow cylinder lies entirely within the crossmember. When the crossmember is weakened according to the invention, its mechanical stability is reduced in principle, but the system pressure prevailing in the hollow cylinder, which is usually up to 400 bar, leads to a stiffening, so that a weight reduction can be achieved without mechanical disadvantages. The simultaneous possible reduction in the overall length of the crossmember also reduces the lever arm formed by the crossmember, so that transverse forces caused by vibrations can be greatly minimized and thus material fatigue reduced. This means that it can easily be accepted that the installation in the crossmember means that the hollow cylinder is only accessible for maintenance purposes via a bolted closure on the side facing away from the crushing jaw. As the swept volume, and thus the piston stroke, are located entirely within the crossmember, the overall length of the device from the crossmember to the drive-connected crushing jaw can be significantly reduced, thus reducing the space required in the crusher.

Material fatigue and the space requirement of the device can be further reduced by the crossmember having a recess as a hollow cylinder which, together with the reciprocating piston inserted therein, limits the swept volume. This means that there is no need for an external cylinder tube including flange as a separate inserted component, so that mechanical weak points such as weld seams or the like can be eliminated. This reduces material fatigue and thus additionally maintenance intensity. The fact that the hollow cylinder is designed as a recess in the crossmember also reduces the mechanical load on the crossmember, since the integrated design means that any forces that occur are transmitted directly via the crossmember evenly into the load-bearing structure of the jaw crusher, enabling a lighter design. In addition, the more compact design of the hollow cylinder as a recess in the crossmember enables further weight savings.

The weight of the crusher can be further reduced and the replacement of wear parts facilitated if the crossmember forms bearing bodies that engage positively in bearing receptacles of the frame as a means of preventing rotation. Usually, forces and torques to be dissipated are transmitted from the device to the frame of the crusher via a materially bonded connection between the crossmember of the device and the frame of the crusher. However, this requires not only appropriate stiffening of the crossmember in the connection area, but also special treatment of the contact surfaces, such as heat treatment for welded connections. The form-fitted bearing arrangement eliminates the need for additional material and complex treatment of the contact surfaces, which simplifies production and further reduces weight. As the crossmember is secured against rotation by the bearing bodies, the forces and moments to be dissipated are efficiently transferred into the frame of the crusher even without a materially bonded connection. Furthermore, the form-fitted bearing allows easier removal and reinstallation of the device, which solves the problem of the difficult replacement of wear parts due to the design. In addition, however, non-positive connections may be provided between the crossmember and the frame, for example to compensate for laterally acting forces. The crossmember can, for example, be rotationally secured either via at least one rotationally asymmetrical bearing body per side or several rotationally symmetrical bearing bodies per side.

Prior to the detection of an uncrushable object and the subsequent retraction by the device, this object may already cause damage to parts of the crusher due to its nature. In order to avoid twisting of the crushing jaw during this time, it is proposed that the crushing jaw is drive-connected to the reciprocating piston so that it can be pivoted relative to the crossmember about a pivot axis that is essentially parallel to the conveying direction of the crushed material. If an uncrushable object enters the crushing chamber, large forces act locally on the crushing jaw. Because the crushing jaw is pivotally connected to the reciprocating piston relative to the crossmember, the crushing jaw can perform a compensating movement immediately, i.e., directly and without active control, until the device actively retracts the crushing jaw. Since it has been found in crusher operation that uncrushable objects in the material flow of the crushed material tend to be located at the edges of the crushing chamber transverse to the conveying direction and transverse to the lifting direction, a pivotable bearing arranged centrally on the crushing jaw does not restrict the functional principle illustrated here. In the simplest case, the pivotable bearing can be implemented with hinges or joints. In a particularly preferred embodiment of the device according to the invention, at least partially spherical pressure shells are provided between the crushing jaw and the reciprocating piston, which allow a horizontal rotary movement of the crushing jaw for force compensation.

In order to transmit the force between the crushing jaw and the device more uniformly, several hollow cylinders can be provided whose swept volumes lie entirely within the crossmember and whose stroke paths can be controlled in groups. Typically, the forces to be dissipated that an uncrushable object in the crushing chamber exerts on the crushing jaw are not distributed equally along the longitudinal axis of the crushing jaw, which is transverse to the conveying direction. These forces can lead to twisting or even damage to the crushing jaw or frame. The group-wise control of the stroke paths means that the relative positions of the pistons to their cylinders can differ in crusher operation and can form different-sized swept volumes. In this way, undesirable forces can be better dissipated locally in that the stroke path of the reciprocating pistons follow, also locally, the force distribution along the longitudinal axis. The pistons can be supported either individually on the crushing jaw or via a common element between the pistons and the crushing jaw. In a particularly preferred embodiment of the device according to the invention, the device comprises three such hollow cylinders whose stroke paths lie on a common plane. A particularly effective dissipation of the forces caused by uncrushable objects is obtained if, in addition, the reciprocating piston is drive-connected to a crushing jaw in such a way that the crushing jaw can be pivoted in an axis parallel to the conveying direction of the material to be crushed.

### BRIEF DESCRIPTION OF THE INVENTION

In the drawing, the subject matter of the invention is shown by way of example, wherein:

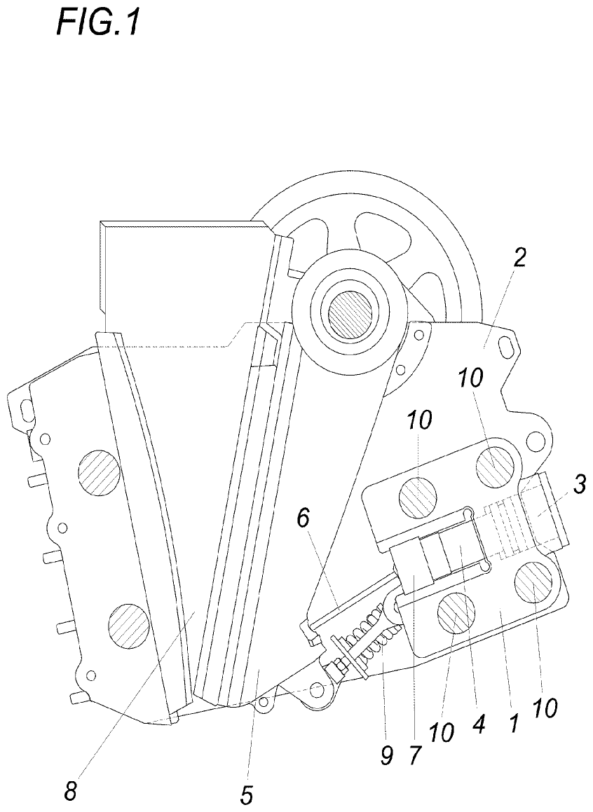

FIG. 1 shows a side view of a device according to the invention and a crushing chamber,

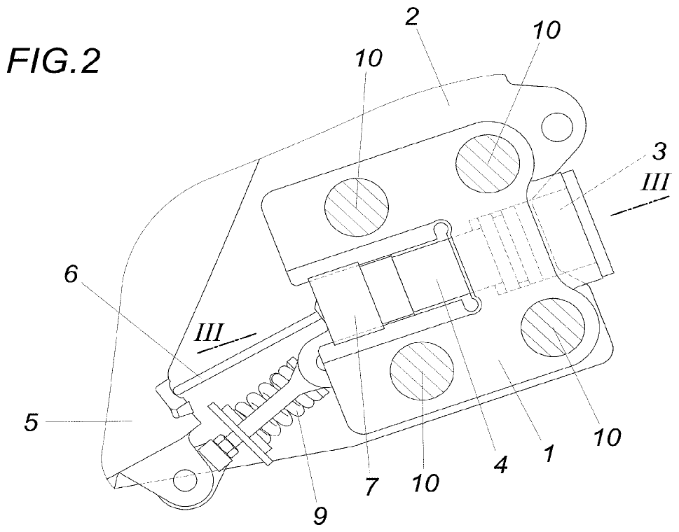

FIG. 2 shows a detailed view of the device corresponding to FIG. 1 on a larger scale,

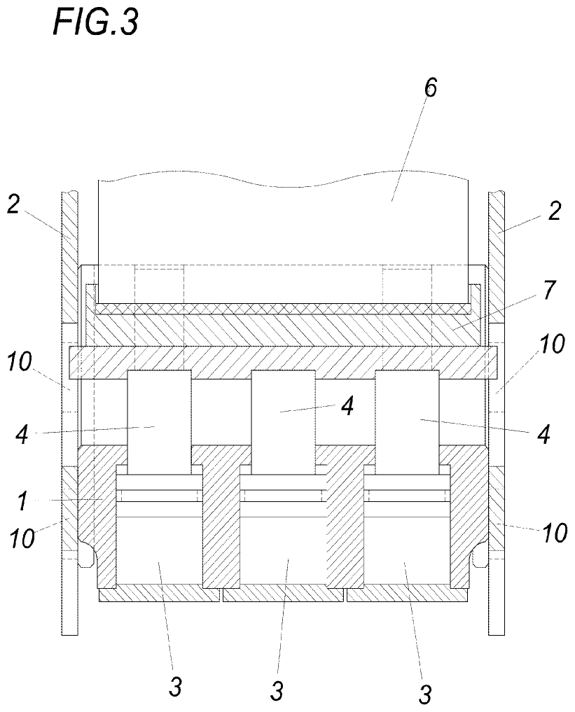

FIG. 3 shows a section along line III-Ill of FIG. 2 and

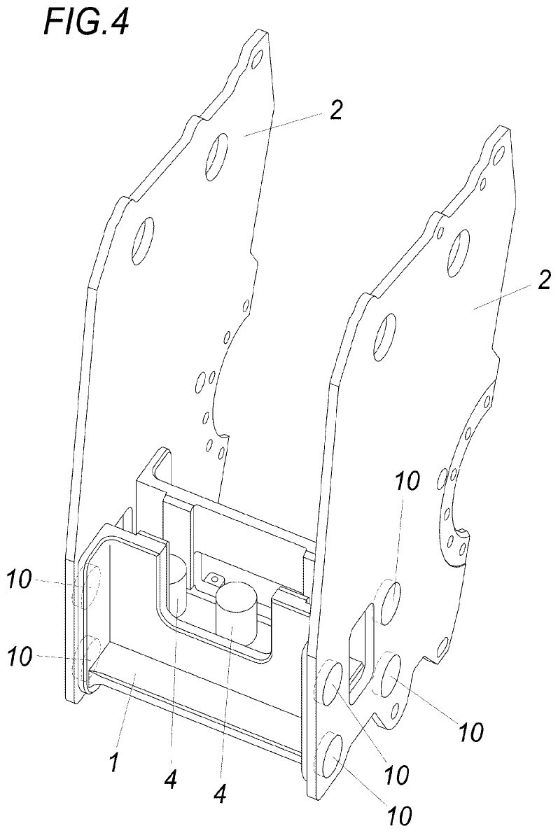

FIG. 4 shows a perspective view of the device on a smaller scale.

### BRIEF DESCRIPTION OF THE PREFERRED EMBODIMENTS

A device according to the invention comprises a crossmember 1 which is mounted in a frame 2. The crossmember 1 has hollow cylinders 3 whose swept volumes lie completely within the crossmember 1. A reciprocating piston 4 is inserted in each of the hollow cylinders 3, which is drive-connected to a crushing jaw 5 and forms a lifting system that can be operated, for example, by means of a hydraulic working medium. The drive connection can be established via a predetermined breaking plate 6, which is placed on the reciprocating pistons 4 via a connecting element 7. The crushing jaw 5 is driven via an eccentric and delimits a crushing chamber 8, wherein the position of the crushing jaw 5 and thus the resulting crushing gap can be adjusted by the lifting system. In this context, the crushing jaw 5 can additionally be connected to the frame 2 in tension via a retraction mechanism, such as a spring 9, the restoring force of which ensures a continuous connection between the crushing jaw 5 and the crossmember 1. As can be seen in FIG. 3, particularly preferred design conditions result when the hollow cylinders 3 are formed as recesses of the crossmember 1, since in this case the compressed working medium in the swept volume stiffens the hollow cylinders 3 against mechanical loads. If an uncrushable object enters the crushing chamber 8, the forces caused by this object are transmitted via the reciprocating pistons 4, which are drive-connected to the crushing chamber 8, to the crossmember 1, from which the forces are transmitted to the frame 2 in a manner that is as gentle as possible on the material and, above all, non-destructive. For this purpose, bearing bodies 10 are provided which positively connect the crossmember 1 to the frame 2 secured against rotation. The reciprocating pistons 4 can compensate for deformations of the crushing jaw 5 caused by uncrushable objects by varying the stroke paths in their hollow cylinders 3.

1. A device for a crusher, said device comprising:
a frame for a crushing chamber,
which frame comprises a crossmember,
a crushing jaw delimiting the crushing chamber said crushing jaw being drivably connected to a reciprocating piston inserted into a hollow cylinder so as to define a swept volume therein,
wherein the swept volume of the hollow cylinder lies completely within the crossmember.

2. The device according to claim 1, wherein the crossmember has a recess therein so as to form the hollow cylinder which, together with the reciprocating piston inserted therein, delimits the swept volume.

3. The device according to claim 1, wherein the crossmember has bearing bodies that engage positively in bearing receptacles of the frame so as to secure the crossmember against rotation relative to the frame.

4. The device according to claim 1, wherein the crushing jaw is pivotable relative to the crossmember about a pivot axis substantially parallel to a conveying direction of material crushed by the device.

5. The device according to claim 1, wherein at least one additional hollow cylinder is supported on the frame, the hollow cylinders having swept volumes that lie completely within the crossmember and stroke paths that are controlled in groups.

6. The device according to claim 2, wherein the crossmember has bearing bodies that engage positively in bearing receptacles of the frame-so as to secure the crossmember against rotation relative to the frame.

7. The device according to claim 2 wherein the crushing jaw is pivotable relative to the crossmember about a pivot axis substantially parallel to a conveying direction of material crushed by the device.

8. The device according to claim 3 wherein the crushing jaw is pivotable relative to the crossmember about a pivot axis substantially parallel to a conveying direction of material crushed by the device.

9. The device according to claim 6 wherein the crushing jaw is pivotable relative to the crossmember about a pivot axis substantially parallel to a conveying direction of material crushed by the device.

10. The device according to claim 2, wherein at least one additional hollow cylinder is supported on the frame, the hollow cylinders having swept volumes that lie completely within the crossmember and stroke paths that are controlled in groups.

11. The device according to claim 3, wherein at least one additional hollow cylinder is supported on the frame, the hollow cylinders having swept volumes that lie completely within the crossmember and stroke paths that are controlled in groups.

12. The device according to claim 4, wherein at least one additional hollow cylinder is supported on the frame, the hollow cylinders having swept volumes that lie completely within the crossmember and stroke paths that are controlled in groups.

13. The device according to claim 6, wherein at least one additional hollow cylinder is supported on the frame, the hollow cylinders having swept volumes that lie completely within the crossmember and stroke paths that are controlled in groups.

14. The device according to claim 7, wherein at least one additional hollow cylinder is supported on the frame, the hollow cylinders having swept volumes that lie completely within the crossmember and stroke paths that are controlled in groups.

15. The device according to claim 8, wherein at least one additional hollow cylinder is supported on the frame, the hollow cylinders having swept volumes that lie completely within the crossmember and stroke paths that are controlled in groups.

16. The device according to claim 9, wherein at least one additional hollow cylinder is supported on the frame, the hollow cylinders having swept volumes that lie completely within the crossmember and stroke paths that are controlled in groups.

17. A device for crushing material, said device comprising:
a frame having two spaced walls with a crushing chamber defined therebetween;
said frame having a transversely extending crossmember between the walls;
a hollow cylinder supported on the frame, said hollow cylinder having a recess supporting a piston therein for reciprocating movement, said piston and the hollow cylinder defining a swept volume in the hollow cylinder defined by the reciprocating movement;
a crushing jaw delimiting the crushing chamber, the crushing jaw being movably supported on the frame and connected with the reciprocating piston so as to move with the reciprocating movement thereof so as to crush material in the crushing chamber;
wherein the swept volume of the hollow cylinder lies completely within the crossmember.

18. The device according to claim 17, wherein the hollow cylinder is formed as a part of the crossmember, such that the recess in the hollow cylinder is in the crossmember.

19. The device according to claim 17, wherein the walls of the frame have bearing receptacles and the crossmember has bearing structures that are received in said bearing receptacles so as to secure the crossmember against rotation relative to the frame.

20. The device according to claim 17, wherein the crushing jaw pivotable relative to the crossmember about a pivot axis substantially parallel to a conveying direction of the material crushed by the device, and
an additional hollow cylinder is supported on the cross member, said additional hollow cylinder having a respective piston that is supported therein for reciprocating movement that defines a swept volume for said additional hollow cylinder that is completely within the crossmember;
said piston in the additional hollow cylinder being connected with the crushing jaw; and
the reciprocating movement of the pistons in the hollow cylinders and stroke lengths thereof being controlled together so as to cooperatively move the crushing jaw to crush the material in the crushing chamber.
